(19) United States
(12) Patent Application Publication
(10) Pub. No.: US 2004/0012467 A1
(43) Pub. Date: Jan. 22, 2004

(54) Multilayered filter

(75) Inventors: Olli Salmela, Helsinki (FI); Ilkka Kelander, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/609,552

(22) Filed: Jul. 1, 2003

(30) Foreign Application Priority Data
Jul. 5, 2002 (FI) 20021328

(51) Int. Cl. H01P 1/203

(52) U.S. Cl. 333/204; 333/203

(57) ABSTRACT

The present invention concerns a multilayered filter having a body consisting of multiple lateral layers, and comprising filter elements of transmission line configuration arranged according to a predetermined topology. According to the invention the filter elements further comprise multiple resonators arranged in two or more lateral layers, at least two resonators per lateral layer. Further according to the invention the filter comprises one or more intermediate partial ground planes, each arranged laterally between two layers.

### FIELD OF THE INVENTION

The present invention relates to electronics. In particular, the present invention relates to a novel and improved multilayered filter.

### BACKGROUND OF THE INVENTION

Filters are components commonly used for example in communication systems, in which they are utilized e.g. to shape waveforms, match impedance, reduce system and image noise, inhibit harmonic emissions and lower interference. They are typically implemented in various configurations, one of which is generally referred to as transmission line configuration. Prior art filters of transmission line configuration are typically planar, i.e. filter elements, such as resonators and feeds, are placed in a single lateral layer or plane. FIGS. 1a and 1b illustrate a typical prior art planar filter of interdigital topology. FIG. 1a provides a view from above, while FIG. 1b provides a side view. As illustrated, the filter comprises resonator strips 0, 1, 2 and 3, which are all arranged on a same lateral layer. Various prior art filters are disclosed e.g. by EP 0 685 898, EP 1 094 538, U.S. Pat. No. 4,701,727, U.S. Pat. No. 6,114,925, U.S. Pat. No. 5,349,314 and U.S. Pat. No. 5,448,209.

However, there are several significant problems with prior art planar filters. If all the filter elements are placed in a same layer, it follows that area consumption typically becomes high. Large surface area in turn means additional costs. Additionally large surface area means restrictions to how much component size can be shrunk. These problems are especially severe in regards to narrow band filters and filters with high degree and/or resonator count.

Another problem with prior art planar filters is that coupling between neighboring resonators of a filter may only be relatively small because of the planar configuration and because of prior art design rule restrictions concerning neighboring transmission line spacing, i.e. the resonators cannot be placed very close to each other. Thus, since bandwidth of the prior art planar transmission line filters is limited to a moderate level, the filters only tend to be of narrow band nature.

Yet another problem with prior art planar filters is that lateral manufacturing tolerances, i.e. line and spacing definition tolerances tend to be poor. Therefore the coupling of resonators and furthermore the whole filtering functionality is heavily affected by said tolerances. Filter performance fluctuation due to said manufacturing tolerances results in poor yield. Furthermore applicability to demanding specifications is severely limited.

Thus there is need for a solution diminishing sensitivity to manufacturing tolerances, minimizing filter size and making it possible to implement broadband filters of transmission line configuration.

### SUMMARY OF THE INVENTION

The present invention concerns a multilayered filter having a body consisting of multiple lateral layers. Layer is a prior art term used to refer to a plane on which conducting wire patterns may be placed. The filter comprises filter elements of transmission line configuration arranged according to a predetermined topology.

According to the invention the filter elements comprise multiple resonators arranged in two or more lateral layers, at least two resonators per lateral layer. Resonator is a prior art term used to refer to a transmission line of quarter-wave or half-wave length. Additionally, the filter may comprise one or more lateral layers comprising no resonators, e.g. in case only relatively slight coupling between given two resonators in different layers is required. At least two of the resonators are edge-coupled, and at least two are broadside-coupled or offset broadside-coupled. Also a combination of edge-coupled, broadside-coupled and offset broadside coupled resonators may be used. Edge-coupled refers to a case of two resonators next to each other in a same layer being coupled to each other. Broadside-coupled refers to a case of two resonators in different layers completely overlapping being coupled to each other. Offset broadside-coupled refers to a case of two resonators in different layers either partly overlapping or non-overlapping being coupled to each other. Further according to the invention the filter comprises one or more intermediate partial ground planes, each arranged laterally between two layers.

In an embodiment of the invention the filter elements further comprise one or more single resonators, each arranged in a lateral layer with no other resonators.

In an embodiment of the invention the filter further comprises a top ground plane arranged laterally on top of the body, and a bottom ground plane arranged laterally on bottom of the body.

In an embodiment of the invention the ground planes are connected to same potential.

In an embodiment of the invention the filter further comprises one or more vias for connecting the ground planes to same potential. Via is a prior art term used to refer to a hole in substrate filled with conductive material.

In an embodiment of the invention the transmission line type used is strip line, i.e. conducting wire placed between two ground planes, each in a different layer. In another embodiment of the invention the transmission line type used is microstrip line, either embedded or non-embedded. Non-embedded microstrip line refers to a case of conducting wire placed on top of a ground plane, and embedded microstrip line refers to a case of conducting wire placed on top of a ground plane but below the surface of the substrate. In yet another embodiment of the invention the transmission line type used is coplanar waveguide, i.e. conducting wire placed between two half-ground planes, each in a same layer. A combination of said transmission line types may also be used.

In an embodiment of the invention the topology used is interdigital, i.e. coupled quarter-wave resonators. In another embodiment of the invention the topology used is hairpin, i.e. resonators of U-shape.

In an embodiment of the invention the filter is implemented using a multilayered circuit board manufacturing process, e.g. Low Temperature Cofired Ceramics (LTCC) or High Temperature Cofired Ceramics (HTCC).

The invention makes it possible to significantly minimize filter size. This is accomplished by diminishing area consumption by using a multilayered structure. This in turn reduces costs. Further, the invention allows significantly more freedom in choosing design parameters, i.e. capacitances between transmission line strips themselves and capacitances between transmission line strips and ground planes. Thus, the invention makes it possible to create broadband filters using transmission lines. Further, the invention diminishes sensitivity to manufacturing tolerances, and thus yield is higher than when using prior art planar filters.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1a illustrates a prior art planar filter,

FIG. 1b illustrates a prior art planar filter,

FIG. 2 illustrates a multilayered filter according to one embodiment of the present invention,

FIG. 3 further illustrates a multilayered filter according to one embodiment of the present invention,

FIG. 4 further illustrates a multilayered filter according to one embodiment of the present invention, and

FIG. 5 further illustrates a multilayered filter according to one embodiment of the present invention.

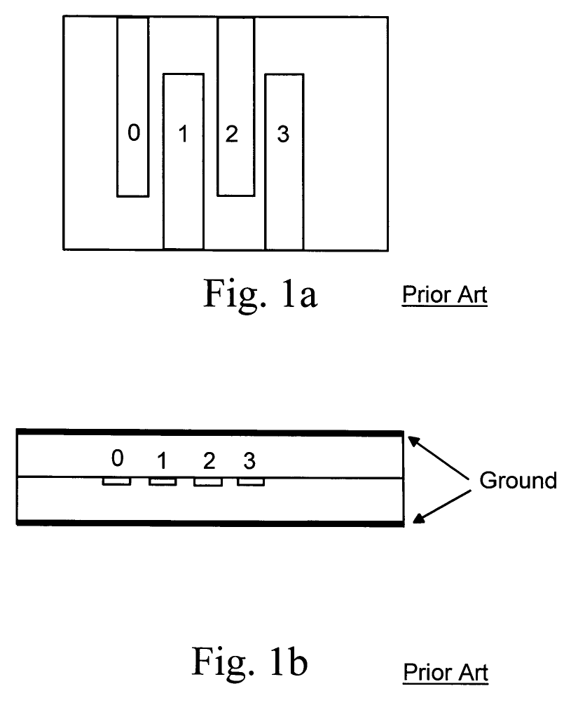

### DETAILED DESCRIPTION OF THE INVENTION

Reference will now be made in detail to the embodiments of the present invention, examples of which are illustrated in the accompanying drawings.

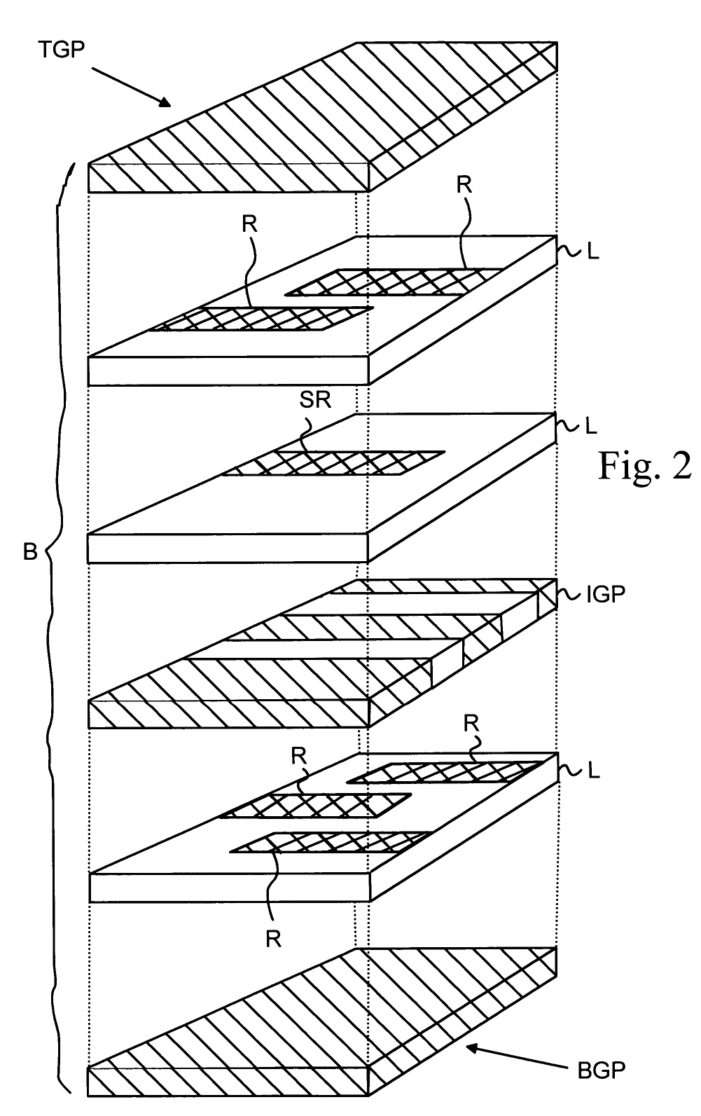

FIG. 2 illustrates a multilayered filter according to one embodiment of the present invention by using an exploded perspective view. In the embodiment of the invention disclosed in FIG. 2 a multilayered filter has a body B consisting of multiple lateral layers L. The filter comprises filter elements of transmission line configuration arranged according to a predetermined topology. The filter elements comprise multiple resonators R arranged in two or more lateral layers, at least two resonators per lateral layer. The resonators are both edge-coupled and broadside-coupled. In the embodiment of the invention disclosed in FIG. 2 the filter further comprises one or more intermediate partial ground planes IGP, each arranged laterally between two layers. The intermediate ground plane being partial refers to it comprising at least one hole. Said hole may be respective to resonators located in the layer above and below said ground plane in order to provide coupling between said resonators. Alternatively, the hole may comprise another resonator. The filter is implemented using a multilayered circuit board manufacturing process, e.g. Low Temperature Cofired Ceramics (LTCC) or High Temperature Cofired Ceramics (HTCC).

In the embodiment of the invention disclosed in FIG. 2 the filter elements further comprise one or more single resonators SR, each arranged in a lateral layer with no other resonators. The filter further comprises a top ground plane TGP arranged laterally on top of the body, and a bottom ground plane BGP arranged laterally on bottom of the body. In the embodiment of the invention disclosed in FIG. 2 the ground planes are connected to same potential. The filter further comprises one or more vias for connecting the ground planes to same potential (not illustrated).

In the embodiment of the invention disclosed in FIG. 2 the transmission line type used is strip line. In another embodiment of the invention the transmission line type used is microstrip line, either embedded or non-embedded. In yet another embodiment of the invention the transmission line type used is coplanar waveguide. Also a combination of said transmission line types may be used. The topology used in the embodiment of the invention disclosed in FIG. 2 is interdigital. Other topologies such as hairpin may also be used.

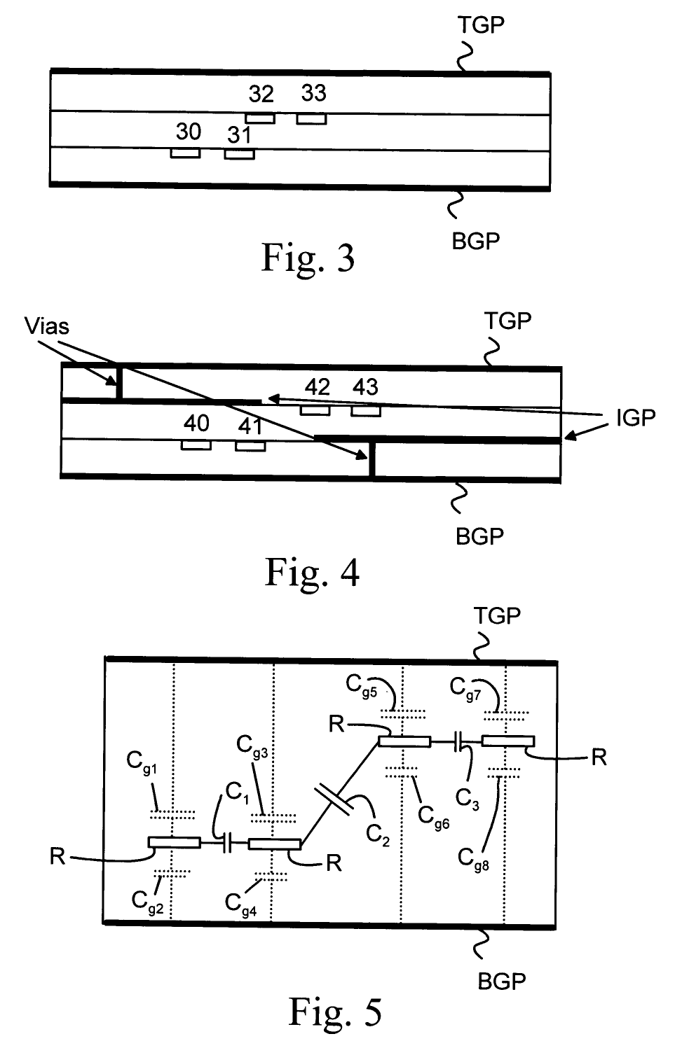

FIG. 3 further illustrates a multilayered filter according to one embodiment of the present invention. In the embodiment of the invention disclosed in FIG. 3 the filter comprises a top ground plane TGP, a bottom ground plane BGP, and resonator strips 30, 31, 32, and 33, of which strips 30 and 31 are arranged on a same lateral layer. Strips 32 and 33 are arranged on another lateral layer. According to the present invention transmission line strips placed on separate layers may overlap totally or partly with each other. This is illustrated in FIG. 3 in which strips 31 and 32 overlap partly with each other. As illustrated in FIG. 3, the filter structure may comprise ground planes only under and on top of the structure, which results in wide conductors and therefore high Q-value. This is due to the fact that in order to create the required transmission line strip-to-ground capacitance, the width of the strip must be large while the strip and ground are far apart from each other.

FIG. 4 further illustrates a multilayered filter according to one embodiment of the present invention. In the embodiment of the invention disclosed in FIG. 4 the filter comprises a top ground plane TGP, a bottom ground plane BGP, two intermediate partial ground planes IGP, and resonator strips 40, 41, 42, and 43, of which strips 40 and 41 are arranged on a same lateral layer. Strips 42 and 43 are arranged on another lateral layer.

As illustrated in FIG. 4, the structure may comprise intermediate partial ground planes IGP in order to add capacitance from a resonator strip to the ground. At the same time the conductor width is reduced and thus area consumption diminishes. Further, as illustrated in FIG. 4, vias may be used to connect the ground planes to a common potential. FIG. 4 further illustrates how an intermediate partial ground plane comprises holes respective to the resonators located in the layer above and below said ground plane in order to provide coupling between said resonators.

FIG. 5 further illustrates a multilayered filter according to one embodiment of the present invention with capacitances shown. Solid lines illustrate capacitances C₁, C₂ and C₃ between consecutive transmission line strips R themselves, and dotted lines illustrate capacitances C_{g1}, C_{g2}, . . . , C_{g8} between transmission line strips R and ground planes TGP and BGP. Design of a multilayered filter according to the invention is based on these capacitances. By selecting the capacitance values correctly one can reach the performance required. When the needed capacitance values are known, the physical dimensions are selected in such a way that both the coupling between the transmission lines and the coupling between the transmission line and the ground plane correspond to the required values.

It is obvious to a person skilled in the art that with the advancement of technology, the basic idea of the invention may be implemented in various ways. The invention and its embodiments are thus not limited to the examples described above, instead they may vary within the scope of the claims.

1. A multilayered filter having a body (B) consisting of multiple lateral layers (L), and comprising filter elements of transmission line configuration arranged according to a predetermined topology,
characterized in that the filter elements comprise:
multiple resonators (R) arranged in two or more lateral layers, two or more resonators per layer and at least two resonators being edge-coupled, and at least two resonators being broadside-coupled or offset broadside-coupled,
and that the filter further comprises:
one or more intermediate partial ground planes (IGP), each arranged laterally between two layers.

2. The filter according to claim 1, characterized in that the filter elements further comprise:
one or more single resonators (SR), each arranged in a lateral layer with no other resonators.

3. The filter according to claims 1 or 2, characterized in that the filter further comprises:
a top ground plane (TGP) arranged laterally on top of the body, and
a bottom ground plane (BGP) arranged laterally on bottom of the body.

4. The filter according to claims 1, 2 or 3, characterized in that the ground planes are connected to same potential.

5. The filter according to claim 4, characterized in that the filter further comprises:
one or more vias (V) for connecting the ground planes to same potential.

6. The filter according to claims 1, 2, 3, 4 or 5, characterized in that the transmission line type used is strip line.

7. The filter according to claims 1, 2, 3, 4 or 5, characterized in that the transmission line type used is microstrip line.

8. The filter according to claims 1, 2, 3, 4 or 5, characterized in that the transmission line type used is coplanar waveguide.

9. The filter according to claims 1, 2, 3, 4, 5, 6, 7 or 8, characterized in that the topology used is interdigital.

10. The filter according to claims 1, 2, 3, 4, 5, 6, 7 or 8, characterized in that the topology used is hairpin.

11. The filter according to claims 1, 2, 3, 4, 5, 6, 7, 8, 9 or 10, characterized in that the filter is implemented using a multilayered circuit board manufacturing process.
